(19) United States
(12) Patent Application Publication
(10) Pub. No.: US 2018/0228237 A1
(43) Pub. Date: Aug. 16, 2018

(54) Eyelashes Unit with Multi-pole Magnetizing Flexible Strip

(71) Applicant: Hongyan ZHANG, Dongguan (CN)

(72) Inventors: Hongyan ZHANG, Dongguan (CN); Liwen ZHAO, Dongguan (CN)

(21) Appl. No.: 15/871,815

(22) Filed: Jan. 15, 2018

(30) Foreign Application Priority Data
Jan. 5, 2017 (CN) 201710005846.8
Nov. 7, 2017 (CN) 201711084249.5

(51) Int. Cl. A41G 5/02; H01F 7/02; H01F 41/00

(52) U.S. Cl. CPC A41G 5/02; H01F 41/00; H01F 7/0252

(57) ABSTRACT

An eyelashes unit with multi-pole magnetizing flexible strip for attaching onto real eyelashes of a user which includes at least one eyelashes member. The eyelashes member includes a pair of flexible magnetic strips and has a plurality pairs of magnetic poles along a longitudinal or a width direction. The pair of flexible magnetic strips are magnetically opposite to each other such that they are capable of attracting to each other with multi-points connection through sandwiching the real eyelashes. A pair of false eyelashes assembly is arranged on the pair of flexible magnetic strips, each includes a plurality of false eyelashes having one end connecting to the flexible magnetic strip to secure into position and a length equal to or greater than a length of the real eyelashes. The flexible magnetic strip is capable of deformation based on an eyelid activity of the user.

### BACKGROUND OF THE PRESENT INVENTION

### Field of Invention

The present invention relates to a cosmetic product and, more particularly to a lashes unit with multi-pole magnetizing flexible strip, which is simple and quick to wear and detach while safe to use.

### Description of Related Arts

Nowadays, beauty or the pursuit of beauty has become parts of people's lives. This is particularly true for women. In order to make their body and appearance more beautiful, some women play sports and exercises. More women select to use a combination of a different cosmetics and make-ups to maintain and decorate themselves based on their own bodies' situation. As we all know, the eye is one of the most important makeup parts of women and therefore eyebrow tattoo, eyeliner tattoo and false eyelashes are commonly used for eye beauty. In particular, through wearing false eyelashes can make the eye more slender, more three-dimensional and more beautiful. Conventional false eyelashes unit includes a connecting portion and false eyelashes which is glued on the connecting portion. On one side of the connecting portion, adhesive is applied. When donning the eyelashes unit, the side with the adhesive of the connecting portion is glued to the eyelid such that human eyelid and eyelashes unit are connected together. The problems of this type of conventional false eyelashes unit and its method of wearing are obvious. First, this type of conventional false eyelashes unit can only be used once and cannot be used repeatedly, so the cost is high. Second, the adhesive will have direct contact to human eye, thereby not only the adhesive may induce stimulating effect on human skin and cause discomfort, but also the adhesive is difficult to remove and the residue may cause eye discomfort. Third, the donning or removal of conventional false eyelashes are very inconvenience.

### SUMMARY OF THE PRESENT INVENTION

An object of the present invention is to solve the above problems and provide an eyelashes unit with multi-pole magnetizing flexible strip, which can be used repeatedly without causing stimulating and damaging effect to eye while its applicability, adaptability and connectivity is high and its donning and removal is convenient and quick.

Additional advantages and features of the invention will become apparent from the description which follows, and may be realized by means of the instrumentalities and combinations particular point out in the appended claims.

According to the present invention, the foregoing and other objects and advantages are attained by an eyelashes unit with multi-pole magnetizing flexible strip, wherein the eyelashes unit comprises:

a first flexible magnetic strip which is arranged for fitting onto upper eyelashes and is magnetized through multi-pole magnetization, wherein the first flexible magnetic strip has a plurality pairs of magnetic poles along a longitudinal direction or a width direction with equal or unequal spacing between the magnetic poles, wherein the first flexible magnetic strip is capable of deformation based on an activity of an eyelid of a user;

a second flexible magnetic strip which is arranged for fitting onto upper eyelashes and is magnetized through multi-pole magnetization, wherein the second flexible magnetic strip has a plurality pairs of magnetic poles along a longitudinal direction or a width direction with equal or unequal spacing between the magnetic poles, wherein the second flexible magnetic strip is capable of deformation based on an activity of an eyelid of a user;

an upper false eyelashes member, which comprises a pair of the first flexible magnetic strip and a pair of first false eyelashes, wherein a polarity of the two first flexible magnetic strip are opposite to each other, wherein the first false eyelash has one end fixedly positioned on a bottom side of the first flexible magnetic strip and another end extended away from the first flexible magnetic strip at a downward direction and having a lash length equal to or greater than a length of real eyelashes of the user;

a lower false eyelashes member, which comprises a pair of the second flexible magnetic strip and a pair of second false eyelashes, wherein a polarity of the two second flexible magnetic strip are opposite to each other, wherein the second false eyelash has one end fixedly positioned on a top side of the second flexible magnetic strip and another end extended away from the second flexible magnetic strip at an upward direction and having a lash length equal to or greater than the length of real eyelashes of the user; and

wherein the upper false eyelashes member and lower false eyelashes member are used, two pieces of the first flexible magnetic strips of the upper false eyelashes member are connected together to sandwich a top side and a bottom side of the real eyelashes of the user through magnetic attraction, and two pieces of the second flexible magnetic strip of the lower false eyelashes member are connected together to sandwich a top side and a bottom side of the real eyelashes of the user through magnetic attraction.

Preferably, the first flexible magnetic strip has a first flexible strip body corresponding to a shape of an upper eyelid of human eye, and has a curved sheet body or a rod-shaped body. The second flexible magnetic strip has a second flexible strip body corresponding to a shape of a lower eyelid of human eye, and has a curved sheet body or a rod-shaped body.

Preferably, the first flexible magnetic strip and the second flexible magnetic strip with a sheet body have a rectangle cross-section and the turner corners has a smooth transition construction so that the edges are smooth and sharp corners are eliminated.

Preferably, the first flexible magnetic strip and the second flexible magnetic strip with a rod-shaped body have a circular cross-section or an oval cross-section, wherein two symmetrical sections along the axial direction are provided for the first flexible magnetic strip and the second flexible magnetic strip with the rod-shaped body and the circular cross-section, and the turner corners has a smooth transition construction so that the edges are smooth and sharp corners are eliminated.

Preferably, the first false eyelashes and the second false eyelashes are secured onto one of the sections of the first flexible magnetic strip and the second flexible magnetic strip with the rod-shaped body and the circular cross-section. The first false eyelashes and the second false eyelashes are secured onto the section of a long side of the first flexible magnetic strip and the second flexible magnetic strip with the rod-shaped body and the oval cross-section.

Preferably, the first flexible magnetic strip and the second flexible magnetic strip has a sheet strip body or rod-shaped strip body having a length which is slightly smaller that the real upper eyelid and the real lower eyelid respectively. The first flexible magnetic strip and the second flexible magnetic strip with the sheet strip body has a width of 0.5˜2 mm and a thickness of 0.05˜0.5 mm. The first flexible magnetic strip and the second flexible magnetic strip with the rod-shaped strip body and circular cross-section have a diameter is 0.05˜2 mm. The first flexible magnetic strip and the second flexible magnetic strip with the rod-shaped strip body and oval cross-section have a length of long axis of 0.05˜2 mm.

Preferably, the false eyelashes of the upper false eyelashes member has one end secured onto the first flexible magnetic strip by hot pressing or bonding, and the false eyelashes of the lower false eyelashes member has one end secured onto the second flexible magnetic strip by hot pressing or bonding.

Preferably, the first and the second flexible magnetic strip are made by mixing uniformly synthetic rubber powder, magnet powder and addictive according to a weight ratio of 1˜10: 75˜98: 1˜10 to form a mixture, and then by calendering, injection molding or calendering and injection molding to form the final product, wherein the magnet powder is selected from the group consisting of neodymium iron boron magnetic (NdFeB magnet) powder, samarium-iron iron powder or samarium cobalt powder, wherein the additive is silane coupling agent.

Preferably, the mixture of the synthetic rubber powder, the magnet powder and the addictive are arranged for calendering, injection molding, or calendering then injection molding in the absence of magnetic field to form the first flexible magnetic strip and the second flexible magnetic strip which are magnetically isotopic.

Preferably, the mixture of the synthetic rubber powder, the magnet powder and the addictive are arranged for calendering, injection molding, or calendering then injection molding under strong magnetic field orientation to form the first flexible magnetic strip and the second flexible magnetic strip which are magnetically anisotropic and are magnetically opposite to each other.

The advantageous effect of the present invention is that the problems of conventional arts are solved effectively. According to the present invention, a flexible strip with multi-pole magnetization is used as a carrier and a connector, false eyelashes are affixed onto the flexible strip for forming an eyelashes unit which can be worn and removed quickly. The eyelashes unit is positioned on the eyelid through magnetic attraction force and therefore discomfort or pain resulting from the use of adhesive is eliminated. Since the eyelashes unit of the present invention utilizes a magnetic connection mechanism, a simple act of putting two eyelashes members on two sides of the real eyelashes is sufficient to complete the connection for donning. During removal, the two eyelashes members are gently removed apart and will be removed. Therefore, the donning and removal are quick and convenient. Also, since the eyelashes unit of the present invention utilizes magnetic connection, no damage will be caused to the eyelashes unit for donning and removal, so the eyelashes unit can be used repeatedly. Furthermore, since the eyelashes unit of the present invention utilizes flexible magnetic strip as the carrier, the eyelashes unit can deform in response to the eyelids activity and provide great fitting and adaptability to the eye so that the user will not have any foreign body sensation and discomfort from the eyelashes unit. Furthermore, the present invention has the characteristics of simple in structure, low cost and easy to use.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 is a schematic view of the structure of an upper false eyelashes member according to a preferred embodiment of the present invention.

FIG. 2 is a sectional view illustration of the upper false eyelashes member according to the above preferred embodiment of the present invention.

FIG. 3 is an exploded view illustration of the upper false eyelashes member according to the above preferred embodiment of the present invention.

FIG. 4 is a schematic view of the structure of a lower false eyelashes member according to the above preferred embodiment of the present invention.

FIG. 5 is a sectional view illustration of the lower false eyelashes member according to the above preferred embodiment of the present invention.

FIG. 6 is an exploded view illustration of the lower false eyelashes member according to the above preferred embodiment of the present invention.

FIG. 7 is a schematic view of the structure of a first flexible magnetic strip according to the above preferred embodiment of the present invention.

FIG. 8 is a cross-sectional view schematic illustration of the structure of the first flexible magnetic strip with a sheet-like structure according to the above preferred embodiment of the present invention.

FIG. 9A is a cross-sectional view schematic illustration of the structure of the first flexible magnetic strip with a rod-like structure, showing a circle-like cross-section according to the above preferred embodiment of the present invention.

FIG. 9B is a cross-sectional view schematic illustration of the structure of the first flexible magnetic strip with a rod-like structure, showing oval-like cross-section according to the above preferred embodiment of the present invention.

FIG. 10 is a schematic view of the structure of a second flexible magnetic strip according to the above preferred embodiment of the present invention.

FIG. 11 is a cross-sectional view schematic illustration of the structure of the second flexible magnetic strip with a sheet-like structure according to the above preferred embodiment of the present invention.

FIG. 12A is a cross-sectional view schematic illustration of the structure of the second flexible magnetic strip with a rod-like structure, showing a circle-like cross-section according to the above preferred embodiment of the present invention.

FIG. 12B is a cross-sectional view schematic illustration of the structure of the second flexible magnetic strip with a rod-like structure, showing oval-like cross-section according to the above preferred embodiment of the present invention.

FIG. 13 is a schematic view showing an in-use condition of the upper false eyelashes member according to the above preferred embodiment of the present invention.

FIG. 14 is a schematic view showing an in-use condition of the lower false eyelashes member according to the above preferred embodiment of the present invention

### DETAILED DESCRIPTION OF THE PREFERRED EMBODIMENT

The preferred embodiment of the present invention is further described with the accompanying drawings as follows and is not intended to be limiting.

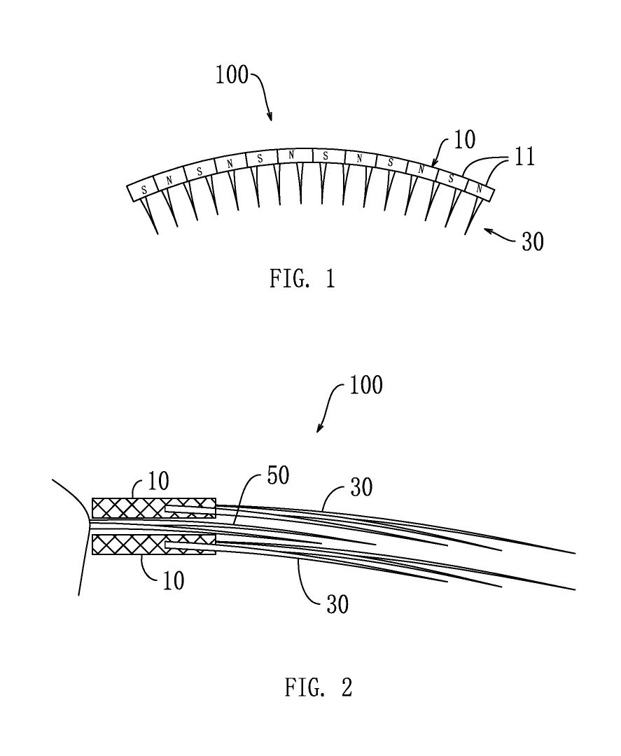

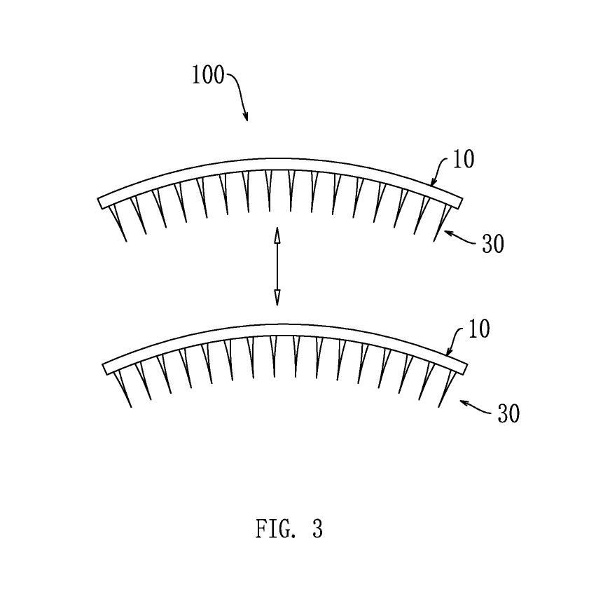

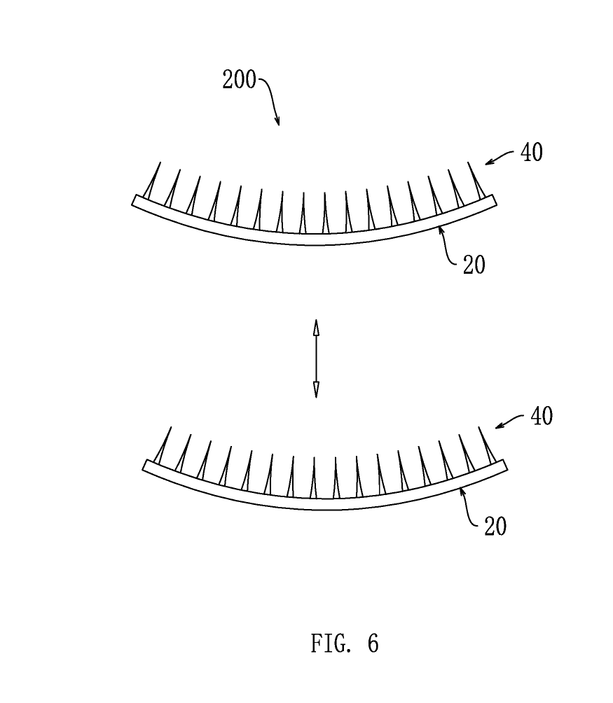

Referring to FIG. 1 to FIG. 6 of the drawings, an eyelashes unit with multi-pole magnetizing flexible strip according to the preferred embodiment of the present invention comprises a first flexible magnetic strip 10, a second flexible magnetic strip 20, an upper false eyelashes member 100, a lower false eyelashes member 200, a first false eyelashes assembly 30 and a second false eyelashes assembly 40, wherein the first false eyelashes assembly 30 is a plurality of false eyelashes 31 which matches upper real eyelashes of a human eye and the second false eyelashes assembly 40 is a plurality of false eyelashes 41 which matches lower real eyelashes of a human eye. Preferably, the first false eyelashes assembly 30 and the second false eyelashes assembly 40 may be made of human hair, animal hair, man-made fiber, plant fiber, etc., which should be highly resemble to real eyelashes 50 of human eye as far as possible.

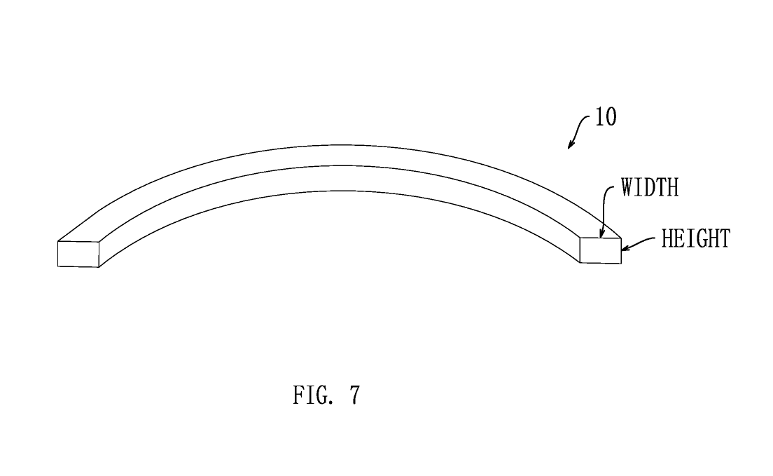

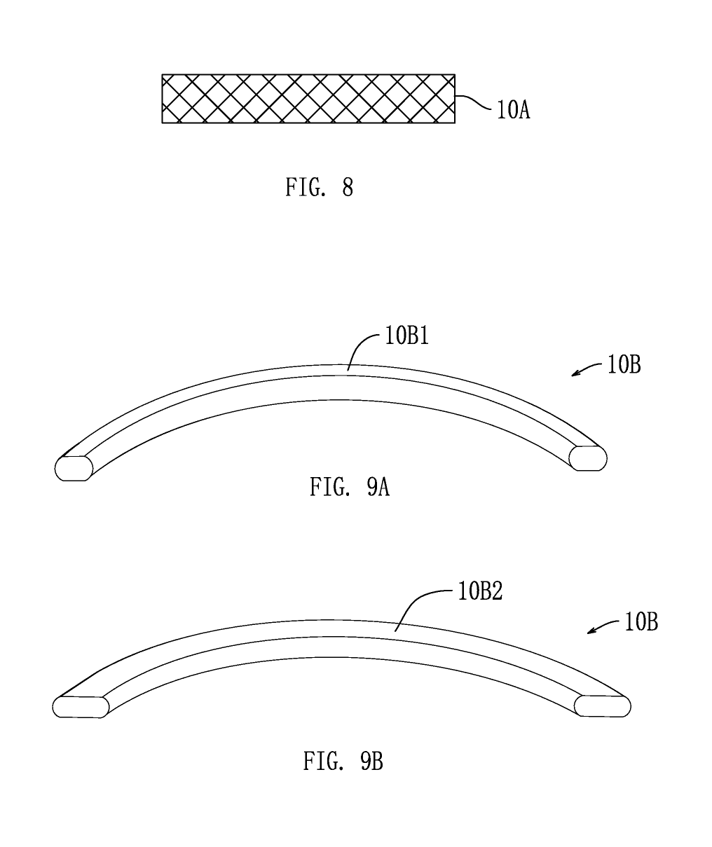

Referring to FIG. 7, FIG. 8, FIG. 9A and FIG. 9B of the drawings, the first flexible magnetic strip 10 has a first flexible magnetic strip body 12 corresponding to a shape of an upper eyelid of a human eye of a user, and is capable of deformation according to an activity of the upper eyelid of the human eye of the user. According to this preferred embodiment, the first flexible magnetic strip body 12 of the first flexible magnetic strip 10 has two opposite long sides 121 and two opposite short sides 122, wherein each of the two long sides 121 defines a curve line having a curvature corresponding to the eyelid of the human eye of the user. The first flexible magnetic strip body 12 can be a generally sheet-like body or a generally rod-like body. It is apparent that the first flexible magnetic strip body 12 can also have a sheet body or rod body.

As shown in FIG. 8 of the drawings, the first flexible magnetic strip has a sheet-like body 10A and has a rectangular cross-section. Preferably, the first flexible magnetic strip has a sheet body 10A with a thickness t₁ of 0.1 mm and a width w₁ of 1 mm. For safety purposes, the four turning corners 123 have a smooth transition construction so that the edges are smooth and sharp corners are avoided.

Referring to FIG. 9A and 9B of the drawings, another embodiment of the first flexible magnetic strip with a rod-like body 10B is illustrated. As shown in FIG. 9A, the first flexible magnetic strip with a rod body 10B can be constructed into a rod body with circle-like cross-section. In the outer surface of the first flexible magnetic strip with a rod body 10B, two symmetrical sections 10B1 along the axial direction are provided so that the connecting surface for connecting to another first flexible magnetic strip is increased. For safety purposes, the four turning corners 123 have a smooth transition construction so that the edges are smooth and sharp corners are avoided. Preferably, the first flexible magnetic strip with a rod body 10B and circle-like cross-section according to this embodiment has a diameter of 1 mm.

As shown in FIG. 9B, the first flexible magnetic strip with a rod-like body 10B can be constructed into a rod body with oval-like cross-section. Preferably, the first flexible magnetic strip with a rod body 10B and oval-like cross-section according to this embodiment has a long axis having a length of 0.1mm.

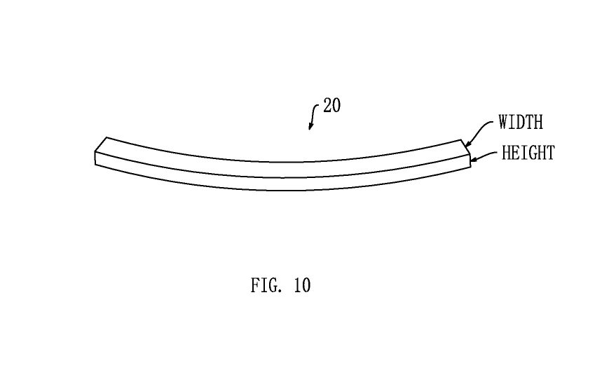

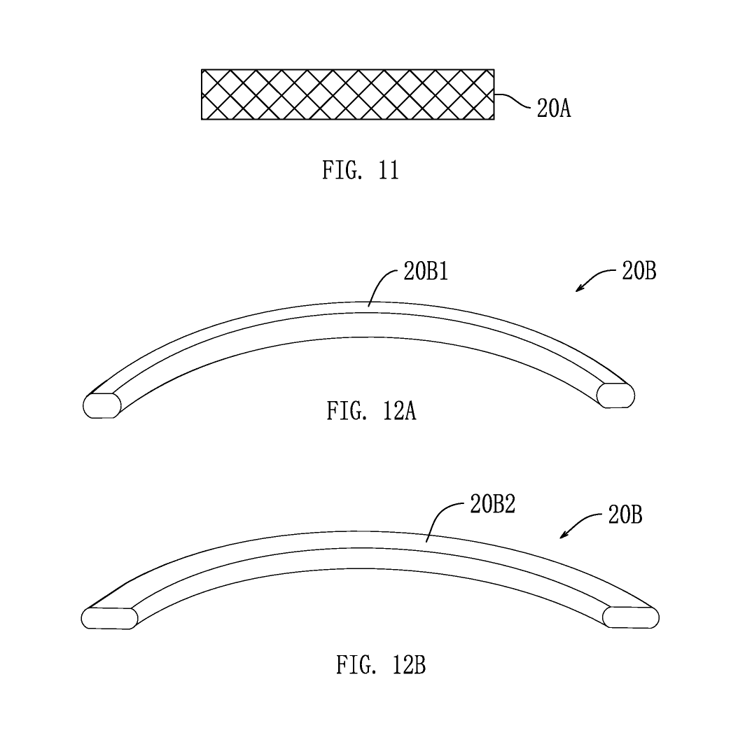

Referring to FIG. 10, FIG. 11, FIG. 12A and FIG. 12B of the drawings, the second flexible magnetic strip 20 has a second flexible magnetic strip body 22 corresponding to a shape of a lower eyelid of the human eye of the user, and is capable of deformation according to an activity of the upper eyelid of the human eye. According to this preferred embodiment, the second flexible magnetic strip body 22 of the second flexible magnetic strip 20 has two opposite long sides 221 and two opposite short sides 222, wherein each of the two long sides 221 defines a curve line having a curvature corresponding to the lower eyelid of the human eye. The second flexible strip body 22 can be a generally sheet-like body 20A or a generally rod-like body 20B. It is apparent that the second flexible magnetic strip body 12 can also have a sheet body or rod body.

As shown in FIG. 11 of the drawings, the second flexible magnetic strip has a sheet-like body 20A and has a rectangular cross-section. Preferably, the second flexible magnetic strip with a sheet-like body 20A has a thickness t₂ of 0.1 mm and a width w₂ of 1 mm. For safety purposes, the four turning corners 223 have a smooth transition construction so that the edges are smooth and sharp corners are avoided.

Referring to FIG. 12A and 12B of the drawings, another embodiment of the second flexible magnetic strip with a rod-like body 20B is illustrated. As shown in FIG. 12A, the second flexible magnetic strip with a rod-like body 20B can be constructed into a rod body with circle-like cross-section. In the outer surface of the second flexible magnetic strip with a rod body 20B, two symmetrical sections 20B1 along the axial direction are provided so that the connecting surface for connecting to another second flexible magnetic strip is increased. For safety purposes, the four turning corners 223 have a smooth transition construction so that the edges are smooth and sharp corners are avoided. Preferably, the second flexible magnetic strip with a rod body 20B and circle-like cross-section according to this embodiment has a diameter of 1mm.

As shown in FIG. 12B, the second flexible magnetic strip with a rod-like body 20B can be constructed into a rod body with oval-like cross-section. Preferably, the second flexible magnetic strip with a rod body and oval-like cross-section 20B according to this embodiment has a long axis having a length of 0.1 mm.

Referring to FIG. 7 to FIG. 12 of the drawings, the first flexible magnetic strip 10 and the second flexible magnetic strip 20 are made of magnetic composite materials. The first and the second flexible magnetic strip 10, 20 are made by mixing uniformly synthetic rubber powder, magnet powder and addictive according to a weight ratio of 5:92:3 through a mixer to form a mixture, and then by calendering or injection molding to form the final product. Alternatively, after mixing, by injection molding and then calendering to form the final product. According to this preferred embodiment, the synthetic rubber powder is manufactured by the step of grinding rubber materials into a powder from, wherein the rubber materials is selected from the group consisting of nitrile rubber, ethylene propylene rubber, chloroprene rubber, butadiene rubber, polyurethane rubber, styrene butadiene rubber, butyl rubber, silicone rubber and thermoplastic rubber. The magnet powder is Neodymium iron boron magnetic (NdFeB magnet) powder. The addictive is silane coupling agent. The magnet powder can also be selected from the group consisting of neodymium iron boron magnetic (NdFeB magnet) powder, samarium iron iron powder or samarium cobalt powder.

According to this preferred embodiment, the mixture of the synthetic rubber powder, the magnet powder and the addictive are arranged for calendering, injection molding, or calendering then injection molding in the absence of magnetic field to form the first flexible magnetic strip 10 and the second flexible magnetic strip 20 which are magnetically isotopic. According to another embodiment, the mixture of the synthetic rubber powder, the magnet powder and the addictive are arranged for calendering, injection molding, or calendering then injection molding under strong magnetic field orientation to form the first flexible magnetic strip 10 and the second flexible magnetic strip 20 which are magnetically anisotropic and are magnetically opposite to each other.

Referring to FIG. 7 and FIG. 10 of the drawings, the first flexible magnetic strip 10 and the second flexible magnetic strip 20 can be magnetized to form a multi-pole structure. The first flexible magnetic strip 10 and the second flexible magnetic strip are processed by a magnetizer for multi-stage magnetization processing so that a plurality pairs of magnetic poles 11 arranged along a longitudinal direction of the magnetic strip are formed on the first flexible magnetic strip 10 and the second flexible magnetic strip 20. It is apparent that the plurality pair of magnetic poles 11 can also be arranged along a width direction of the magnetic strip while a distance between the magnetic poles 11 may be equal or unequal. Since a plurality pairs of magnetic poles are arranged on the entire strip of the first flexible magnetic strip 10 and the second flexible magnetic strip 20, the upper false eyelashes member 100 and the lower false eyelashes member 200 which are manufactured by using the upper false eyelashes member 100 and the lower false eyelashes member 200 will have multi-points of reliable connection along the longitudinal direction when in-use. In other words, multi-points of magnetic attraction are formed on the first flexible magnetic strip, thereby the two first flexible magnetic strips 10 of the upper false eyelashes member 100 are connected to each other by a multiple points of connections.

Referring to FIG. 1 to FIG. 3 of the drawings, the upper false eyelashes member 100 comprises a pair of first flexible magnetic strip 10 and a pair of first false eyelashes assembly 30, wherein a polarity of the two first flexible magnetic strip 10 are opposite to each other. If one of the first flexible magnetic strip 10 has a multi-pole alignment of S-N, S-N, S-N, . . . , then the other first flexible magnetic strip 10 will have a multi-pole alignment of N-S, N-S, N-S, . . . , so that the opposite magnetic poles of the two first flexible magnetic strip 10 will be attracted together when they are connecting together for use. Preferably, the first false eyelash assembly 30 may be made of human hair, animal hair, man-made fiber, plant fiber, etc., which should be highly resemble to a shape and a color of the real eyelash 50 of human eye as far as possible. The first false eyelash assembly 30 has one end fixedly positioned on a bottom side of the first flexible magnetic strip 10 and another end extended away from the first flexible magnetic strip 10 at a downward direction and having a lash length Li equal to or greater than a length of the real eyelash 50. In particular, for the first flexible strip having a sheet-like body 10A, the first false eyelash assembly 30 has one end fixedly positioned on one bottom side of the first flexible magnetic strip 10A through hot pressing or bonding. According to this preferred embodiment, the first false eyelash assembly 30 is fixedly positioned onto the first flexible strip having a sheet-like body 10A by hot pressing. For the first flexible magnetic strip with a rod-like body 10B and circle-like cross-section, the first false eyelash assembly 30 is fixedly positioned onto one section 10B1 by hot pressing. For the first flexible magnetic strip with a rod-like body 10B and oval-like cross-section, the first false eyelash assembly 30 is fixedly positioned onto the section 10B2 of one long side by hot pressing.

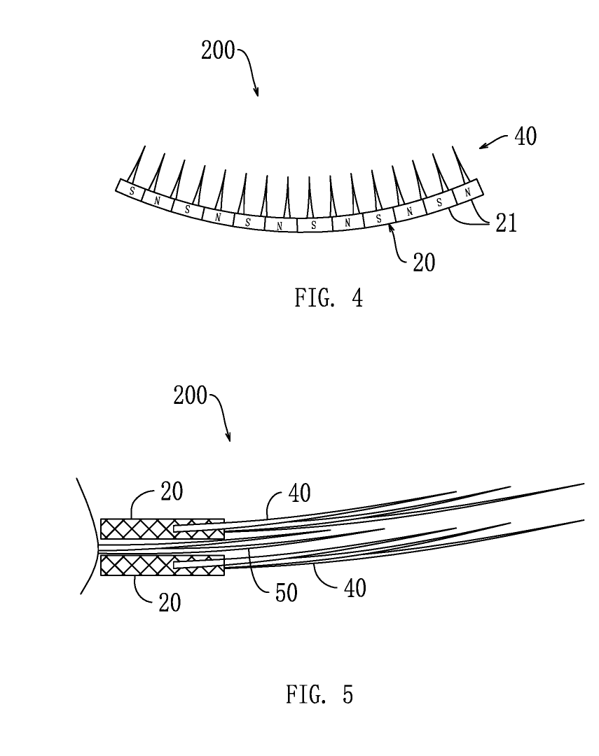

Referring to FIG. 4-6 of the drawings, the lower false eyelashes member 200 comprises a pair of second flexible magnetic strip 20 and a pair of second false eyelashes assembly 40, wherein a polarity of the two second flexible magnetic strip 20 are opposite to each other. If one of the second flexible magnetic strip 20 has a multi-pole alignment of S-N, S-N, S-N, . . . , then the other second flexible magnetic strip 20 will have a multi-pole alignment of N-S, N-S, N-S, . . . , so that the opposite magnetic poles of the two second flexible magnetic strip 20 will be attracted together when they are connecting together for use. Preferably, the second false eyelash assembly 40 may be made of human hair, animal hair, man-made fiber, plant fiber, etc., which should be highly resemble to a shape and a color of the real eyelash 50 of human eye as far as possible. The second false eyelash assembly 40 has one end fixedly positioned on a top side of the second flexible magnetic strip 20 and another end extended away from the second flexible magnetic strip 20 at an upward direction and having a lash length L₂ equal to or greater than a length of the real eyelash 50. In particular, for the second flexible strip having a sheet-like body 20A, the second false eyelash assembly 40 has one end fixedly positioned on a top side of the second flexible magnetic strip 20A through hot pressing or bonding. According to this preferred embodiment, the second false eyelash assembly 40 is fixedly positioned onto the second flexible strip having a sheet-like body 20A by hot pressing. For the second flexible magnetic strip with a rod-like body 20B and circle-like cross-section, the second false eyelash assembly 40 is fixedly positioned onto one section 20B1 by hot pressing. For the second flexible magnetic strip with a rod-like body 20B and oval-like cross-section, the second false eyelash assembly 40 is fixedly positioned onto the section 20B2 of one long side by hot pressing.

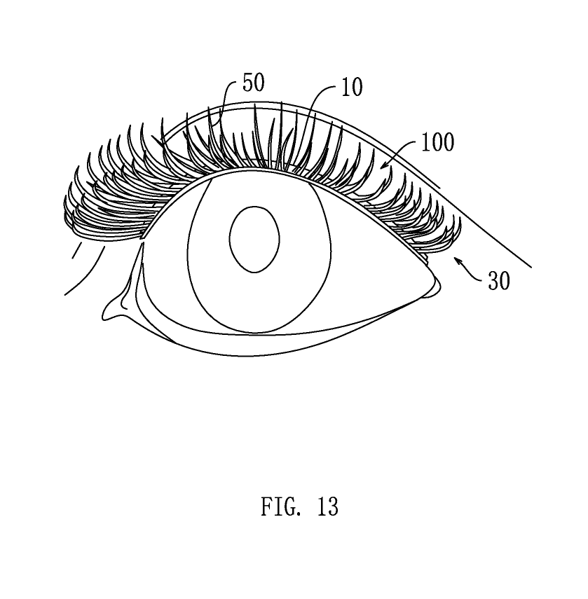

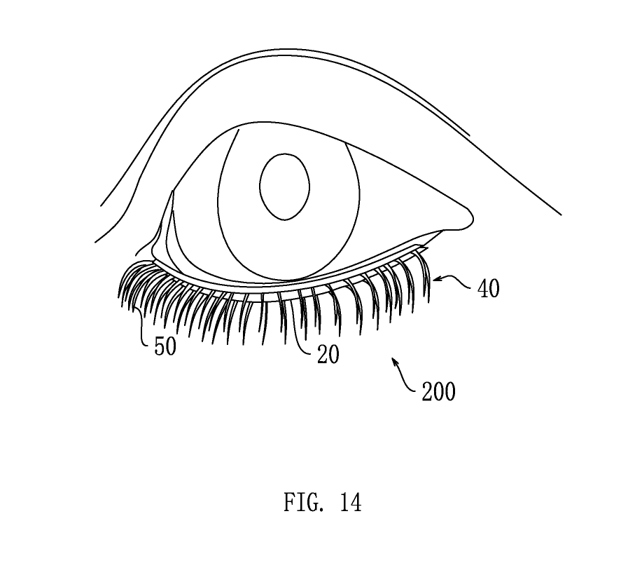

Referring to FIG. 13 and FIG. 14 of the drawings, When donning the upper false eyelashes member 100 and the lower false eyelashes member 200, by using special eyelash curler or bare hands, the pair of upper false eyelashes member 100 can be connected to the real eyelashes 50 at a top and a bottom sides through magnetic attraction, and the pair of lower false eyelashes member 200 can be connected to the real eyelashes 50 at a top and a bottom sides through magnetic attraction, thereby achieving the beautifying effect of eyelashes and provide an aesthetically pleasing result.

According to the present invention, through the use of a flexible magnetic strip which is capable of bending and deformation as the carrier, false eyelashes are fixed positioned onto the carrier, therefore an eyelashes unit with beautifying effect and aesthetically pleasing result while providing quick and convenient donning and removal and safe is achieved.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An eyelashes unit with multi-pole magnetizing flexible strip for attaching onto real eyelashes of a user, comprising at least one eyelashes member, each said eyelashes member comprises:
a pair of flexible magnetic strips which is arranged for fitting onto upper eyelashes or lower eyelashes, each said flexible magnetic strip has a plurality pairs of magnetic poles through multi-pole magnetization processing and said pair of flexible magnetic strips are magnetically opposite to each other such that said pair of flexible magnetic strips are capable of attracting to each other for securing into position through sandwiching the real eyelashes of the user; and
a pair of false eyelashes assembly arranged on said pair of flexible magnetic strips respectively, wherein each said false eyelashes assembly comprises a plurality of false eyelashes having one end connecting to said flexible magnetic strip to secure into position and having a length equal to or greater than a length of the real eyelashes of the user,
wherein each said flexible magnetic strip has a flexibility and is capable of deformation based on an activity of an eyelid of the user.

2. The eyelashes unit with multi-pole magnetizing flexible strip according to claim 1, wherein said plurality pairs of magnetic poles of each said flexible magnetic strip is aligned along a longitudinal direction.

3. The eyelashes unit with multi-pole magnetizing flexible strip according to claim 1, wherein said plurality pairs of magnetic poles of each said flexible magnetic strip is aligned along a width direction.

4. The eyelashes unit with multi-pole magnetizing flexible strip according to claim 1, wherein said plurality pairs of magnetic poles of each said flexible magnetic strip is aligned along a longitudinal direction while a distance between two said magnetic poles is equal.

5. The eyelashes unit with multi-pole magnetizing flexible strip according to claim 1, wherein each said flexible magnetic strip has a sheet-like body and a rectangular cross-section.

6. The eyelashes unit with multi-pole magnetizing flexible strip according to claim 4, wherein each said flexible magnetic strip has a sheet-like body and a rectangular cross-section.

7. The eyelashes unit with multi-pole magnetizing flexible strip according to claim 1, wherein each said flexible magnetic strip has a rod-like body.

8. The eyelashes unit with multi-pole magnetizing flexible strip according to claim 4, wherein each said flexible magnetic strip has a rod-like body and has a circular cross-section.

9. The eyelashes unit with multi-pole magnetizing flexible strip according to claim 4, wherein each said flexible magnetic strip has a rod-like body and has an oval-like cross-section.

10. The eyelashes unit with multi-pole magnetizing flexible strip according to claim 1, wherein said flexible magnetic strip has a flexible strip body corresponding to a shape of an upper eyelid of the user arranged for fitting to the upper eyelashes of the user.

11. The eyelashes unit with multi-pole magnetizing flexible strip according to claim 6, wherein said flexible magnetic strip has a flexible magnetic strip body corresponding to a shape of an upper eyelid of the user arranged for fitting to the upper eyelashes of the user, wherein said flexible magnetic strip body has a width of 0.5˜2 mm and a thickness of 0.05˜0.5 mm.

12. The eyelashes unit with multi-pole magnetizing flexible strip according to claim 8, wherein said flexible magnetic strip has a flexible magnetic strip body corresponding to a shape of an upper eyelid of the user arranged for fitting to the upper eyelashes of the user, wherein a diameter of the circular cross-section is 0.05˜2 mm.

13. The eyelashes unit with multi-pole magnetizing flexible strip according to claim 9, wherein said flexible magnetic strip has a flexible magnetic strip body corresponding to a shape of an upper eyelid of the user arranged for fitting to the upper eyelashes of the user, wherein a the oval cross-section along of long axis is 0.05˜2 mm.

14. The eyelashes unit with multi-pole magnetizing flexible strip according to claim 1, wherein said flexible magnetic strip has a flexible magnetic strip body corresponding to a shape of a lower eyelid of the user arranged for fitting to the lower eyelashes of the user.

15. The eyelashes unit with multi-pole magnetizing flexible strip according to claim 6, wherein said flexible magnetic strip has a flexible magnetic strip body corresponding to a shape of a lower eyelid of the user arranged for fitting to the lower eyelashes of the user, wherein said flexible magnetic strip body has a width of 0.5˜2 mm and a thickness of 0.05˜0.5 mm.

16. The eyelashes unit with multi-pole magnetizing flexible strip according to claim 8, wherein said flexible magnetic strip has a flexible magnetic strip body corresponding to a shape of a lower eyelid of the user arranged for fitting to the lower eyelashes of the user, wherein a diameter of the circular cross-section is 0.05˜2 mm.

17. The eyelashes unit with multi-pole magnetizing flexible strip according to claim 9, wherein said flexible magnetic strip has a flexible magnetic strip body corresponding to a shape of a lower eyelid of the user arranged for fitting to the lower eyelashes of the user, wherein a the oval cross-section along of long axis is 0.05˜2 mm.

18. The eyelashes unit with multi-pole magnetizing flexible strip according to claim 1,
wherein said flexible magnetic strip are prepared by the step of
(a) mixing uniformly synthetic rubber powder, magnet powder and addictive according to a weight ratio of 1˜10:75˜98:1˜10 to form a mixture, and
(b) forming a final product of said flexible magnetic strip by a process selected from the group consisting of calendering, injection molding, and calendering and injection molding,
wherein said magnet powder is selected from the group consisting of neodymium iron boron magnetic (NdFeB magnet) powder, samarium iron iron powder or samarium cobalt powder,
wherein said additive is silane coupling agent.

19. The eyelashes unit with multi-pole magnetizing flexible strip according to claim 18, wherein in the step (b), said process is carried out in the absence of magnetic field so that said final product of flexible magnetic strip is magnetically isotopic.

20. The eyelashes unit with multi-pole magnetizing flexible strip according to claim 18, wherein in the step (b), said process is carried out under strong magnetic field orientation so that said final product of flexible magnetic strip is magnetically anisotropic.
